(19) United States
(12) Patent Application Publication
(10) Pub. No.: US 2003/0227097 A1
(43) Pub. Date: Dec. 11, 2003

(54) Method of fabricating a polymer part with a negative thermal expansion coefficient and a polymer part obtained by the method

(75) Inventors: Valerie Girardon, Bretigny/Orge (FR); Herve Loury, Chatillon-En-Vendelais (FR)

Correspondence Address: SUGHRUE MION, PLLC, Suite 800, 2100 Pennsylvania Avenue, Washington, DC, 20037-3213, US

(73) Assignee: ALCATEL

(21) Appl. No.: 10/449,672

(22) Filed: Jun. 2, 2003

(30) Foreign Application Priority Data
Jun. 10, 2002 (FR) 02 07 081

(51) Int. Cl. B29D 11/00; B29C 45/00

(52) U.S. Cl. 264/1.24; 264/157; 264/328.2

(57) ABSTRACT

A method of fabricating a polymer part having a negative thermal expansion coefficient includes injecting a thermotropic polymer under controlled temperature and pressure conditions into a mold having an injection inlet substantially equal to the thickness of the part and a length that causes elongation of the polymer.

### CROSS-REFERENCE TO RELATED APPLICATIONS

This application is based on French Patent Application No. 02 07 081 filed Jun. 10, 2002, the disclosure of which is hereby incorporated by reference thereto in its entirety, and the priority of which is hereby claimed under 35 U.S.C. §119.

### BACKGROUND OF THE INVENTION

1. Field of the Invention

The present invention relates to a method of fabricating a polymer part having a negative longitudinal thermal expansion coefficient (TEC) over a wide temperature range. A part of this kind finds an application as an optical component support.

2. Description of the Prior Art

Optical components can be packaged in supports of various kinds depending on the component type and the intended applications. Thus optical components can be placed in polymer or ceramic supports, for example. The components envisaged in the context of the present invention can be passive components, for example, such as Bragg gratings photowritten into optical waveguides or arrayed waveguide grating (AWG) multiplexers/demultiplexers.

Some optical components, such as fiber components in particular, are subject to temperature drift caused by a thermo-optical effect and a positive thermal expansion coefficient in the operating temperature range of the component. As the external temperature varies, the effective refractive index η_{eff} of the waveguide is modified, which modifies the optical properties of the fiber.

In particular, when a Bragg grating is written into a fiber portion, the wavelength of the resulting filter is given by the Bragg equation:

λ_{B}=2Λη_{eff} [1]

in which η_{eff} is the effective refractive index of the optical waveguide in which the grating is photowritten, which is generally made of doped silica, and Λ is the pitch of the grating, i.e. the distance between two successive index modulations in the optical waveguide.

Thus modification of the effective index η_{eff} or the pitch Λ of the grating leads ipso facto to modification of the Bragg wavelength and therefore of the spectral response of the filter. A Bragg grating optical filter is therefore sensitive to temperature and to traction, these effects conventionally being used to adjust or tune optical filters in many applications known in the art.

However, when not induced intentionally, the temperature sensitivity of a filter constitutes a problem to be solved. Optical components have an operating temperature range of the order of 100° C. (generally from −10° C. to +70° C.) which can shift the Bragg wavelength λ_{B} by up to 1 nm.

The following equation expresses the thermal variation of the Bragg wavelength:

dλ_{B}/dT=2Λ (dη_{eff}/dT+η_{eff}. α_{guide}) [2]

where dη_{eff}/dT is the thermo-optical effect and α_{guide} is the thermal expansion coefficient of the material of the guide. The Bragg wavelength λ_{B} is therefore stabilized in relation to temperature variations dT by compensating the thermo-optical effect of the waveguide, which is inherent, by a thermo-mechanical effect that modifies the parameter α_{guide}. Conventionally, with no thermal compensation, a Bragg grating has a temperature sensitivity Δλ_{B}/ΔT of the order of 10 pm/K.

This kind of problem is well known in the art to which the invention relates and is identified in particular in the paper by G. W. Yoffe et al, “Temperature-compensated optical fiber Bragg gratings”, OFC'95, Technical Digest, W14, pp134-135. The above publication proposes to solve the problem mentioned above by fixing a fiber with a Bragg grating into a mount incorporating an Invar tube, of low thermal sensitivity, associated with a material of high thermal sensitivity. The combination of the two materials is such that the temperature drift of the fiber with the Bragg grating is compensated by appropriate traction or compression of the fiber portion. However, this kind of solution is complicated to put into practice.

Another prior art solution for compensating temperature drifts of an optical component consists of packaging the component in a support having a negative thermal expansion coefficient in order to counterbalance the effects of thermal drift on the optical behavior of the component.

To this end, ceramic supports for optical components have been proposed. In particular, U.S. Pat. No. 6,506,699 proposes a method of fabricating a ceramic part having a negative thermal expansion coefficient from −2.5.10⁻⁶/° C. to −10.10⁻⁶/° C. over a temperature range from −40° C. to +160° C. Supports of this kind meet the optical constraints of thermal compensation but are costly and fragile. Ceramic supports consist of friable inorganic materials, imposing difficult handling precautions.

Polymer component packaging has been proposed to overcome these price and fragility problems. In particular, U.S. Pat. No. 6,067,392 proposes an optical fiber with a Bragg grating comprising a polymer coating having a negative thermal expansion coefficient. As shown in FIG. 1, the fiber 10 (made of a silica-based material and incorporating a photowritten Bragg grating 12) is surrounded by an inner coating 14 of a resin containing silicone and an outer coating 16 of liquid crystalline polymer. An identification coating 18 can optionally be added, consisting of a resin that is sensitive to ultraviolet light. The fiber 10 and the internal coating 14 have a positive thermal expansion coefficient that is compensated by the negative thermal expansion coefficient of the outer coating 16. Thus the optical component consisting of the fiber 10 with the Bragg grating 12 has stable behavior over a wide temperature range thanks to the compensation effect of the outer coating 6.

The above U.S. Pat. No. 6,067,392 also describes a method of fabricating a liquid crystalline polymer of the above kind with a negative thermal expansion coefficient. The method described consists in stretching the polymer while extruding it through a die to orient the crystal in tension in a given direction. This method can produce a crystalline polymer part taking the form of a film, tube or filament. In the main application described and previously mentioned, the polymer obtained is used as an optical fiber coating 16 and is approximately 300 μm thick. However, the above method requires perfectly homogeneous coatings to guarantee isotropic behavior all along the photowritten Bragg grating.

In another application described in the above patent and shown in FIG. 2 thereof, a polymer part 61 taking the form of a 2 mm thick support is obtained by the above kind of extrusion method. The liquid crystalline material is oriented in a direction in the plane of the support. The part 61 is used as a support for optical fibers 10 fixed to said part by means of an epoxy adhesive 70. The fibers can be placed in V-shaped grooves machined into the support part 61. However, the extrusion method is not suitable for producing solid parts like these.

In the case of an arrayed waveguide grating (AWG) component conventionally used for multiplexing and/or demultiplexing or wavelength selection applications, temperature variations affect the optical behavior of the component.

Broadly speaking, an AWG component integrated onto a substrate of silicon, for example, conventionally includes input waveguides transmitting optical signals at wavelengths λ₁i, λ₂, . . . λₙ in an input coupler toward an waveguide array in which the optical signals are phase-shifted and then focused by an output coupler into output waveguides. Each optical signal undergoes the following operations:

diffraction in the input coupler, mathematically represented by the Fourier transform of the signal undergoing the diffraction, each waveguide of the array on the output surface of the coupler receiving a portion of the diffracted wave,

phase shifting in the waveguide array with varying optical paths, the optical path taken in a waveguide of the grating being expressed as a function of the effective refractive index η_{eff} and the length of the waveguide; the phase shifts produce constructive interference at the output of the waveguide array in, a direction depending on the wavelength, and

focusing on the output surface of the coupler of constructive interference between waves coming from the guides of the array.

The phase shifting of the optical signals in the AWG waveguide array is essential to the operation of the component and the temperature sensitivity of each waveguide of the array leads to modification of the optical properties of the component.

One prior art solution for stabilizing the above kind of component in terms of temperature consists in using appropriate mounts, such as that described in the paper by Jorg Hubner, “Polymer Waveguides and Devices”, Tech Univ. Of Denmark, OFC 2002. A polymer having a high negative thermal expansion coefficient is used as a coating for the multilayer structure of the waveguide array. However, this kind of coating layer applies stresses to the waveguides and modifies the phase distribution within the waveguide array, which degrades the performance of the AWG component.

An object of the present invention is to propose another method of producing a polymer part having a negative thermal expansion coefficient. The method according to the invention is based on the injection molding technique. Until now, the person skilled in the art has not succeeded in obtaining a polymer part having a negative thermal expansion coefficient using this technique because the negative thermal expansion coefficient was related to stretching of the polymer (by the extrusion process), which forced the crystalline material into a particular orientation.

Thus an objective of the present invention is to propose a method of injection molding a polymer part having a negative thermal expansion coefficient. That objective is achieved by the use of a suitable mold and precise control of time, temperature and pressure parameters of the injection molding process.

### SUMMARY OF THE INVENTION

The invention provides a method of fabricating a polymer part having a negative thermal expansion coefficient, the method including a step of injecting a thermotropic polymer under controlled temperature and pressure conditions into a mold having an injection inlet substantially equal to the thickness of the part and a length adapted to cause elongation of the polymer.

According to one feature of the invention the polymer is injected at a temperature from 290° C. to 360° C. and at a pressure from 200 Bar to 1 500 bar and a maintenance pressure of the polymer in the mold is from 200 bar to 1 500 bar.

According to an advantageous feature of the invention the polymer is injected at a pressure less than or equal to the maintenance pressure.

According to one feature of the invention the mold includes a reservoir for collecting injection surplus.

The invention also provides a solid polymer part obtained by a fabricating method according to the invention and having a negative thermal expansion coefficient from −4.10⁻⁶ to −10.10⁻⁶.

The features and advantages of the invention will become more clearly apparent on reading the following description, which is given by way of illustrative and nonlimiting example and with reference to the accompanying drawings.

### BRIEF DESCRIPTION OF THE DRAWINGS

FIG. 1, already described, shows an optical fiber having a polymer coating with a negative thermal expansion coefficient obtained by a prior art technique.

FIG. 2, already described, shows an optical fiber support consisting of a polymer part with a negative thermal expansion coefficient obtained by a prior art technique.

FIG. 3 is a diagram of a mold used in a method according to the invention.

FIG. 4 is a diagram of a part injection molded by a method according to the invention.

FIG. 5 is a graph showing the temperature sensitivity of the Bragg wavelength of a filter disposed on a support as shown in FIG. 4 for various temperature cycles.

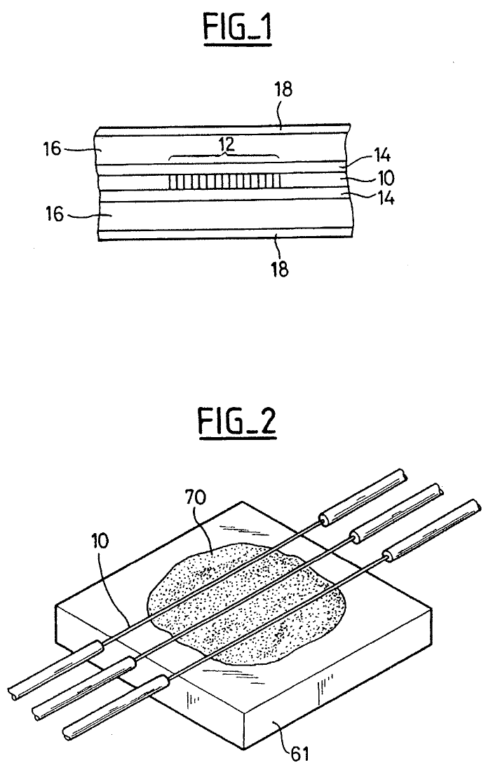

### DETAILED DESCRIPTION OF THE PREFERRED EMBODIMENTS

The present invention relates to a method of fabricating a polymer part having a negative thermal expansion coefficient. The invention preferably, although not exclusively, seeks to obtain this kind of part in solid form for applications to optical component supports, for example. The polymer constituting the part that is the subject matter of the invention is a thermotropic polymer, usually known as a liquid crystal polymer (LCP), such as Vectra A950, for example.

According to the invention, the above kind of polymer part is produced by an injection molding technique. This kind of technique is known in itself, but not in this application to producing a polymer part having a negative thermal expansion coefficient, which requires, firstly, the use of an appropriate mold and, secondly, appropriate control of temperature and pressure conditions during injection.

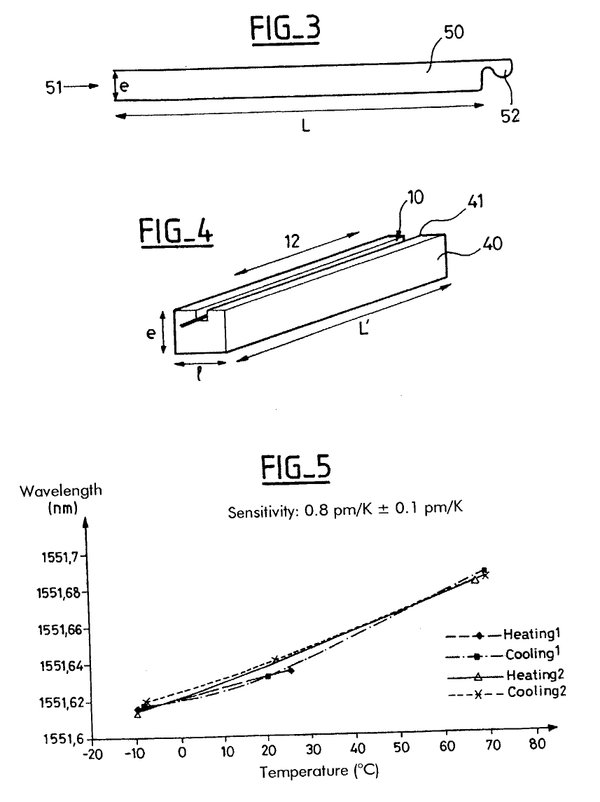

FIG. 3 is a diagram showing a mold that can be used to injection mold a polymer part according to the invention. The mold 50 has an internal shape corresponding to the required shape of the part to be fabricated. An injection inlet 51 is provided at one end of the mold 50. According to the invention, the injection inlet 51 is substantially equal to the thickness e of the polymer part to be fabricated. Also, the mold has a length L much greater than the thickness e of the part, for example ten times greater (L≧10*e).

Under particular injection molding operating conditions, this particular shape of the mold has the advantage of producing a flow of polymer material along a unidirectional axis leading to regular orientation of the molten polymer in a longitudinal plane of the molded part. It is this elongation of the polymer in the mold during injection, under operating conditions described later, that causes the particular orientation of the polymer and determines the negative thermal expansion coefficient of the part.

The mold 50 has a reservoir 52 at the end opposite the injection inlet 51. The reservoir 52 prevents the injected material flowing back toward the interior of the mold, which would disrupt the required crystalline orientation.

The method according to the invention therefore includes a step of injection molding a liquid crystalline polymer in a mold under particular operating conditions, as previously described.

The parameters defining the injection molding operating conditions are well known to the person skilled in the art, who knows how to adapt them to suit the application. The parameters concerned are conventionally the injection temperature (the temperature of the injected material), the injection pressure (the flowrate of the material entering the mold), the maintenance pressure (the pressure in the mold containing the injected material), the maintenance time (molding time), the temperatures of the mold and the shaft, and the rotation speed of the injection screw.

According to the invention, the operating conditions are precisely determined to obtain the negative longitudinal thermal expansion coefficient of the part. The table below shows the thermal expansion coefficient obtained with various injection molding operating conditions in accordance with the invention using Vectra LCP:

| | | Injection | Maintenance |
|---|---|---|---|
| TEC/° C. 10⁻⁶ | Injection T (° C.) | P (Bar) | P (Bar) |
| (−7.9)-(−7.6) | 290-310 | 200 | 1500 |
| (−7.7)-(−7.2) | 290-310 | 500 | 500 |
| (−4.3)-(−4.0) | 290-310 | 500 | 1500 |

In particular, the orientation of the polymer is favored by increasing the maintenance pressure with a low injection pressure. The maintenance time in the mold is from 2 seconds to 6 seconds, approximately.

The injection step can be followed by a step of cutting the injected part in order to retain for use only a portion in which the polymer has a perfectly regular orientation of the crystal in a longitudinal plane. This cutting step may be necessary in particular if the part to be fabricated must have a length less than the length of the mold.

FIG. 5 shows a part obtained by the method according to the invention. The part 40 has a length L′ much greater than its thickness e. On the other hand, using the method according to the invention, the width l of the part 40 can be substantially equal to its thickness e. Furthermore, there is no limit on the thickness e of the part, which can easily exceed 2 mm.

Moreover, a part obtained by injection molding, even if thin (<2 mm thick), has the advantage of not being subject to any buckling deformation in the event of temperature variations, which occurs with conventional parts obtained by extrusion. Buckling deformation consists in longitudinal undulations of the part caused by an increase in temperature.

The part can incorporate a groove 41, for example for positioning a fiber 10 with a Bragg grating 12. The groove can be obtained directly when injection molding the part in an appropriately shaped mold, requiring no subsequent machining step. For example, this kind of groove 41 protects the fiber 10 where it is bared over the portion with the Bragg grating 12. Similarly, the part 40 can have locating lugs or any other mechanical feature, as produced by an appropriate mold, provided that the overall longitudinal orientation of the molded liquid crystalline polymer is not disrupted. Similarly, the polymer part according to the invention can be designed to receive an AWG.

The FIG. 5 graph shows the behavior of a Bragg grating on a fiber disposed on a polymer support part according to the invention, for example as shown in FIG. 4. The Bragg grating has a temperature sensitivity Δλ_{B}/ΔT of the order of 0.8 pm/K to 1 pm/K, as against the 10 pm/K previously mentioned with reference to an uncompensated Bragg grating. In particular, as the FIG. 5 graph shows, the low temperature sensitivity remains stable over a wide range and for several temperature cycles, “heating 1, 2” and “cooling 1, 2” respectively designating the heating and cooling cycles of the Bragg grating.

There is claimed:

1. A method of fabricating a polymer part having a negative thermal expansion coefficient, said method including a step of injecting a thermotropic polymer under controlled temperature and pressure conditions into a mold having an injection inlet substantially equal to the thickness of said part and a length adapted to cause elongation of said polymer.

2. The method claimed in claim 1 wherein said polymer is injected at a temperature from 290° C. to 360° C. and at a pressure from 200 Bar to 1 500 bar and a maintenance pressure of said polymer in said mold is from 200 bar to 1 500 bar.

3. The method claimed in claim 2 wherein said polymer is injected at a pressure less than or equal to said maintenance pressure.

4. The method claimed in claim 1 wherein said mold includes a reservoir for collecting injection surplus.

5. The method claimed in claim 1 further including a step of cutting the injected part transversely.

6. A solid polymer part having a negative thermal expansion coefficient from −4.10⁻⁶ to −10.10⁻⁶ obtained by a fabricating method including a step of injecting a thermotropic polymer under controlled temperature and pressure conditions into a mold having an injection inlet substantially equal to the thickness of said part and a length adapted to cause elongation of said polymer.

7. The polymer part claimed in claim 6 having a thickness greater than 2 mm.

8. An optical component support comprising a solid polymer part having a thickness greater than 2 mm and a negative thermal expansion coefficient from −4.10⁻⁶ to −10.10⁻⁶.
